(19) United States
(12) Patent Application Publication
(10) Pub. No.: US 2023/0356823 A1
(43) Pub. Date: Nov. 9, 2023

(54) MANIFOLD PIPE ASSEMBLIES FOR PROVIDING INERT ATMOSPHERES AND METHODS AND SYSTEMS FOR THE USE THEREOF

(71) Applicant: Innovative Marine and Industrial Services LLC, Dallas, TX (US)

(72) Inventors: Andrew Etter, Houston, TX (US); Rudy De La Fuente, Lantana, TX (US); Edward J. Green, Sewickley, PA (US)

(21) Appl. No.: 18/133,860

(22) Filed: Apr. 12, 2023

Related U.S. Application Data
(60) Provisional application No. 63/339,787, filed on May 9, 2022.

(51) Int. Cl. B63J 2/02; F16L 41/03; F17C 13/04

(52) U.S. Cl. CPC B63J 2/02; F16L 41/03; F17C 13/04; F17C 2205/0146; F17C 2270/0105; F17C 2205/0338; F17C 2205/0332; F17C 2221/014; F17C 2221/016; F17C 2250/043

(57) ABSTRACT

Manifold pipe assemblies and methods and systems for providing an inert atmosphere aboard cargo ships, especially cargo ships having vessels or containers that require a low oxygen environment, are provided herein. A benefit of the manifold pipe assemblies can be using pure nitrogen from a source vessel, such as a liquid nitrogen truck, to quickly and simultaneously purge multiple vessels aboard one or more cargo ships. Another benefit of the manifold pipe assemblies can be to safely adapt high pressure purge gas sources, such as liquid nitrogen trucks, for purging vessels by incorporation a pressure regulating valve and a pressure release valve.

### CROSS-REFERENCE TO RELATED APPLICATIONS

This application is a Non-Provisional application and claims priority to U.S. Provisional Application No. 63/339,787, filed on May 9, 2022, entitled, “MANIFOLD PIPE ASSEMBLIES FOR PROVIDING INERT ATMOSPHERES AND METHODS AND SYSTEMS FOR THE USE THEREOF,” the entirety of which is incorporated by reference.

### TECHNICAL FIELD

The present disclosure relates to manifold pipe assemblies and methods and systems for quickly and safely providing an inert atmosphere aboard cargo ships, especially cargo ships having vessels or containers that require a low oxygen environment.

### BACKGROUND

Cargo ships are used extensively to transport chemicals, combustible materials, and other oxidizable substances. These cargo ships frequently require an inert atmosphere to prevent cargo degradation and for compliance with safety regulations. For example, a typical chemical cargo ship may require a percent of oxygen in the air inside the vessel to be less than or equal to 7% to avoid flammability issues. For more oxygen sensitive chemicals, an oxygen concentration of less than 1000 ppm is desired.

Conventional methods of replacing an ambient atmosphere with an inert atmosphere in such vessels include purging with an inert gas, such as nitrogen, by connecting to a single nitrogen line that pumps nitrogen from a nitrogen gas tank into the vessel aboard the cargo ship. This process can take around 24 to 36 hours to purge each vessel (or hold) aboard a cargo ship. Such long purge durations are undesirable in the shipping industry because time is money. Having dozens of cargo ships waiting in a busy harbor with crews standing by waiting for a purging process is inefficient and leads to high lost opportunity costs.

Another conventional method for providing a nitrogen gas atmosphere in vessels on cargo ships is to install a nitrogen generating device in the cargo ships that can burn diesel fuel to provide clean nitrogen to be used as a purge gas. Such nitrogen generators can provide an inert atmosphere of about 5% oxygen or less in the vessels, but they tend be slow, expensive, and permanently installed on the ship. Furthermore, such devices can tend to breakdown and require expensive maintenance.

A third conventional method can be to supply nitrogen gas from load terminal in a port. However, the rate tends to be inconsistent, and it results in delaying cargo operations at the cargo terminal.

There is a need for a method of providing an inert atmosphere quickly and efficiently in cargo ships that at least addresses the above-mentioned problems with the existing methods. There is a need for a method of providing an inert atmosphere at sites other than the cargo terminal and without the use of expensive machinery.

### SUMMARY

A manifold pipe assembly for providing an inert atmosphere in a destination vessel aboard a cargo ship is disclosed herein. In some embodiments, the manifold pipe assembly includes: a manifold section connected to a pipe section; wherein the manifold section includes: an intake inlet at a manifold proximal end configured to receive a purge gas from a source vessel at an initial intake pressure; a pressure regulating valve mounted on the manifold section, proximal to the intake inlet and configured to reduce or limit a pressure of the received purge gas from the initial intake pressure to a maximum intake pressure; and a pressure release valve mounted on the manifold section at a manifold distal end; wherein the pipe section includes two or more gas pipes connected to the manifold section between the pressure regulating valve and the pressure release valve, wherein at least one of the two or more gas pipes have a pipe proximal end connected to the manifold section and a pipe distal end that is configured to connect with a vessel cargo line connected to the destination vessel aboard the cargo ship, and wherein the pipe distal end terminates in a threaded joint or flange. In some embodiments of the manifold, the pressure regulating valve is configured to maintain a pressure of the purge gas within the manifold section and the pipe section at a maximum safety pressure, wherein the maximum safety pressure is higher than the maximum intake pressure and lower than the initial intake pressure. In some embodiments of the manifold, the pipe section comprises from 2 to 52 gas pipes; or wherein the threaded joint is a Dixon Ground joint. In some embodiments of the manifold, the initial intake pressure is from about 1.37 MPa to about 4.82 MPa; or wherein the maximum intake pressure is from about 0.413 MPa to about 0.517 MPa; or wherein the maximum safety pressure is from about 0.689 MPa to about 0.792 MPa. In some embodiments, one or more of the gas pipes includes a flow valve, including 2 or more of, including a majority of, including each of the gas pipes includes a flow valve. In some embodiments of the manifold, the purge gas comprises nitrogen, argon, or mixtures thereof; or wherein the manifold section and the pipe section comprise steel. In some embodiments, the manifold further includes a pressure sensor disposed on the manifold section between the pressure regulating valve and the pressure release valve, wherein the pressure sensor is configured to monitor an operating pressure of the manifold section; or further comprising at least one flowmeter mounted on a gas pipe of the pipe section and configured to measure a flow rate of purge gas passing through the gas pipe. In some embodiments of the manifold, the intake inlet is configured to connect to a source vessel hose having an internal diameter of about 2.5 cm to about 10.2 cm; or wherein pipe distal end is configured to connect to a vessel cargo line having an internal diameter of about 2.5 cm to about 20.4 cm; or wherein the manifold section has an internal diameter of from about 5.0 cm to about 20.0 cm.

A method for providing an inert atmosphere in a destination vessel aboard a cargo ship is disclosed herein. In some embodiments, the method includes providing a manifold pipe assembly, the manifold pipe assembly comprising: a manifold section connected to a pipe section; wherein the manifold section includes: an intake inlet at a manifold proximal end; a pressure regulating valve mounted on the manifold section proximal to the intake inlet; and a pressure release valve mounted on the manifold section at a manifold distal end; wherein the pipe section includes two or more gas pipes connected to the manifold section between the pressure regulating valve and the pressure release valve, wherein at least one of the two or more gas pipes have a pipe proximal end connected to the manifold section and a pipe distal end that terminates in a threaded joint; connecting the intake inlet to a source vessel containing a purge gas in a gas or liquid form; and connecting the threaded joint of the pipe distal end to a vessel cargo line, wherein the vessel cargo line is connected to the destination vessel aboard the cargo ship. In some embodiments, the method further includes passing purge gas from the source vessel into the intake inlet; and reducing the initial intake pressure to a maximum intake pressure by passing the purge gas through the pressure regulating valve, wherein the initial intake pressure is from about 1.37 MPa to about 4.82 MPa; or wherein the maximum intake pressure is from about 0.413 MPa to about 0.517 MPa. In some embodiments, the method further includes flowing the purge gas through the pipe section and the vessel cargo line to the destination vessel; and reducing an oxygen content of an atmosphere in the destination vessel to from about 10 ppm to about 70,000 ppm volume of oxygen, based on a total volume of the destination vessel. In some embodiments of the method, the destination vessel has a capacity of from about 367,000 liters to about 3,000,000 liters; or wherein the source vessel contains liquid nitrogen; or wherein the source vessel is a vehicle containing liquid nitrogen, a truck containing liquid nitrogen, a boat containing liquid nitrogen, or a raft or dock containing liquid nitrogen. In some embodiments, the method further includes before passing purge gas from the source vessel, connecting a source vessel hose to the source vessel and to the intake inlet, wherein the source hose has an internal diameter of from about 3.8 cm to about 9.0 cm. In some embodiments, the method further includes, before flowing the purge gas through the pipe section, connecting a vessel cargo line to the pipe distal end, wherein the vessel cargo line has an internal diameter of from about 5.0 cm to about 11.0 cm; or before flowing the purge gas through the pipe section, connecting a gas exit hose to the destination vessel to an exit port of the destination vessel, wherein the gas exit hose has an exit end that extends from about 3.0 meters to about 20 meters away from the destination vessel. In some embodiments, the method further includes maintaining a pressure in the manifold section of an operating pressure by configuring the pressure regulating valve to a maximum intake pressure and configuring the pressure release valve to release pressures exceeding the operating pressure, wherein the operating pressure is from about 0.689 MPa to about 0.792 MPa. In some embodiments, the method includes monitoring an operating pressure of the manifold pipe assembly by a pressure sensor disposed on the manifold section between the pressure regulating valve and the pressure release valve; or further comprising, regulating a pressure of purge gas, in each of two or more gas pipes by a flowmeter mounted on the two or more gas pipes. In some embodiments, the pressure regulating valve is connected to the manifold by a 0.635 cm to 1.27 cm (¼ inch to ½ inch) pipe which regulates the operation of the regulating valve by way of the gas pressure in the manifold.

A system for providing inert atmosphere in a destination vessel aboard a cargo ship is disclosed herein. In some embodiments, the system includes: a source vessel connected to a manifold pipe assembly, wherein the manifold pipe assembly is connected to the destination vessel aboard the cargo ship, wherein the manifold pipe assembly comprises: a manifold section connected to a pipe section; wherein the manifold section includes: an intake inlet at a manifold proximal end configured to receive a purge gas from the source vessel at an initial intake pressure; a pressure regulating valve mounted on the manifold section proximal to the intake inlet and configured to limit or reduce a pressure of the received purge gas from the intake value to a maximum intake pressure; and a pressure release valve mounted on the manifold section at a manifold distal end; wherein the pipe section includes two or more gas pipes connected to the manifold section between the pressure regulating valve and the pressure release valve, wherein at least one of the two or more gas pipes have a pipe proximal end connected to the manifold section and a pipe distal end that is configured to connect with a vessel cargo line connected to the destination vessel aboard the cargo ship, and wherein the pipe distal end terminates in a threaded joint or flange.

### BRIEF DESCRIPTION OF DRAWINGS

The foregoing summary, as well as the following detailed description of the embodiments, will be better understood when read in conjunction with the attached drawings. For the purpose of illustration, there are shown in the drawings some embodiments, which may be preferable. It should be understood that the embodiments depicted are not limited to the precise details shown. Unless otherwise noted, the drawings are not to scale.

FIG. 1 is an illustration that presents a view of a top of the manifold pipe assembly, in accordance with an embodiment of the present disclosure.

FIG. 2 is an illustration that presents a left side view of the manifold pipe assembly of FIG. 1, in accordance with an embodiment of the present disclosure.

FIG. 3 is an illustration that presents a top view of the manifold pipe assembly of FIG. 1, in accordance with an embodiment of the present disclosure.

FIG. 4 is an illustration that presents a front view of the manifold pipe assembly of FIG. 1, in accordance with an embodiment of the present disclosure.

Embodiments of the present disclosure now will be described more fully with reference to the accompanying drawings, in which some, but not all embodiments of the disclosures are shown. Indeed, these disclosures may be embodied in many different forms and should not be construed as limited to the embodiments set forth herein. Instead, these embodiments are provided to facilitate understanding. Unless otherwise noted, like numbers refer to like objects throughout.

### DETAILED DESCRIPTION OF DISCLOSURE

Unless otherwise noted, all measurements are in standard metric units.

Unless otherwise noted, all instances of the words “a,” “an,” or “the” can refer to one or more than one of the word that they modify.

Unless otherwise noted, the phrase “at least one of” means one or more than one of an object. For example, “at least one of the two or more gas pipes have a pipe proximal end connected to the manifold section and a pipe distal end that terminates in a threaded joint” means a single gas pipe, a two gas pipes, three gas pipes, four or more gas pipes, or any combination thereof.

Unless otherwise noted, the term “about” refers to ±10% of the non-percentage number that is described, rounded to the nearest number to the accuracy shown. For example, about 105.3 mm, would include 94.8 to 115.8 mm Unless otherwise noted, the term “about” refers to ±5% of a percentage number. For example, about 20% would include 15 to 25%. When the term “about” is discussed in terms of a range, then the term refers to the appropriate amount less than the lower limit and more than the upper limit. For example, from about 100 to about 200 mm would include from 90 to 220 mm.

Unless otherwise noted, the terms “provide”, “provided” or “providing” refer to the supply, production, purchase, manufacture, assembly, formation, selection, configuration, conversion, introduction, addition, or incorporation of any element, amount, component, reagent, quantity, measurement, or analysis of any method or system of any embodiment herein.

Unless otherwise noted, properties (height, width, length, ratio etc.) as described herein are understood to be averaged measurements.

Conventional methods for purging vessels aboard a cargo ship typically take 24 to 36 hours per hold or vessel because they are typically performed one hold at a time. Further, permanently installing a nitrogen generating device in the cargo ship may be undesirable due to high maintenance costs, frequent mechanical problems, and the environmental impact of burning fuel to provide a steady supply of nitrogen gas. Further, many conventional nitrogen supply methods purge at rates that are slow or inconsistent.

The manifold pipe assembly of the present disclosure, as well as the methods and systems for using such a manifold pipe assembly, were inspired by notion that there has to be a better way of quickly and safely providing cargo ships with a lower oxygen inert atmosphere.

It has been discovered that a manifold pipe assembly can be made that effectively allows for multiple vessels aboard one or more cargo ships to be simultaneously purged, instead of one at a time. It has been discovered that this manifold pipe assembly can be adapted to provide purge gases, such as nitrogen, from a liquid gas source, such as liquid nitrogen, which allows for embodiments of the manifold pipe assembly to provide satisfactory purging capacity and an inert atmosphere of about 5% oxygen or below in the vessel.

Further, multiple holds on a cargo ship can be successfully and simultaneously purged down to an oxygen level of about 5% or below at rates four times as quickly as the newest onboard nitrogen generators. The rate of purging depends on tank size and desired oxygen content. For example, it has been found that an embodiment of the manifold pipe assembly can have 4 lines that can provide 4000 m³ per hour each such that a 3000 m³ tank needing to be purged from ambient (210,000 ppm oxygen) to 50 ppm oxygen would take about 9 hrs, using 36,000 m³ of nitrogen.

It is believed that liquid nitrogen or highly pressured nitrogen gasses have not been used in the past because the pressures provided by such gas sources were considered dangerously high. The holds or vessels of cargo ships are designed to carry vast amounts of liquid. However, the holds are not designed to withstand air pressure from within. The holds or vessels of cargo ship cannot withstand even low air pressures, such as 0.01765 MPa (2 psi). Therefore, accidentally pressurizing the holds above their safety thresholds would raise enormous safety issues.

To put this challenge into perspective, standard liquid nitrogen trucks have a pressure ranging from about 34 MPa to about 103 MPa. If the pressure used to purge is too low, then the processing time for purging becomes less efficient and more expensive for the ships being purged. If the pressure used to purge is too high, then it becomes a safety hazard for the ships being purged because enormous back pressures may build up. It has been discovered that the disclosed embodiments of manifold pipe assembly can provide a safe range for purging the holds of ships at safe pressures of from about 0.413 MPa to about 0.517 MPa, which are designed to be compatible with the maximum working pressure of a ships piping which is 0.68 MPa.

Further, instead of using a nitrogen generating device that will slowly provide nitrogen over a long period of time, the disclosed manifold pipe assembly can be connected a to a source vessel (e.g., liquid nitrogen trucks). Therefore, the source of the nitrogen will be very pure, and the process of purging will be efficient due to ease of buying liquid nitrogen from commercial companies and ease of delivery (e.g. in liquid nitrogen trucks) to the purging sites. For example, it's possible to buy liquid nitrogen at 99.95% purity, which can be advantageous because the purer the source of nitrogen gas, the less nitrogen that needs to be used. The disclosed method for providing an inert atmosphere in a destination vessel aboard a cargo ship using the disclosed embodiments of manifold pipe assembly is faster than the existing methods and can obtain oxygen levels of 5% or less, often in less than 3 hours. In addition, due to the use of liquid nitrogen, the nitrogen gas is obtained at pressures high enough to sustain the purging process over long periods of time without the need for an additional pump in-line. Thus, the use of high-pressure source vessels avoids the fuel costs, maintenance problems, and environmental impacts of using an on-ship mechanical nitrogen pump.

Also, instead of connecting a single nitrogen source or a source vessel to a single destination vessel (or hold) to be purged, the disclosed manifold pipe assembly provides a “splitter function” that allows multiple destination vessels or holds to be purged simultaneously. For example, the splitter function allows anywhere from 2 to 52 gas pipes to be connected in parallel to hoses leading to destination vessels, such that the disclosed manifold pipe assembly can effectively purge all the holds of a cargo ship simultaneously, thereby reducing the processing time needed for the purge operation.

Embodiments of a manifold pipe assembly for providing an inert atmosphere in a destination vessel aboard a cargo ship are disclosed. In some embodiments, the manifold pipe assembly includes a manifold section connected to a pipe section. In some embodiments, the manifold section includes an intake inlet at a manifold proximal end configured to receive a purge gas from a source vessel at an initial intake pressure. In some embodiments, the manifold section further includes a pressure regulating valve mounted on the manifold section, proximal to the intake inlet and configured to reduce or limit a pressure of the received purge gas from the initial intake pressure to a maximum intake pressure. In some embodiments, the manifold section further includes a pressure release valve mounted on the manifold section at a manifold distal end.

In some embodiments, the pipe section includes two or more gas pipes connected to the manifold section between the pressure regulating valve and the pressure release valve, wherein at least one of the two or more gas pipes have a pipe proximal end connected to the manifold section and a pipe distal end that is configured to connect with a vessel cargo line connected to the destination vessel aboard the cargo ship, and wherein the pipe distal end terminates in a threaded joint or flange. In some embodiments, the pipe section includes two or more gas pipes connected to the manifold section between the pressure regulating valve and the pressure release valve, wherein at least one of the two or more gas pipes have a pipe proximal end with a flow valve connected to the manifold section to allow one or more of the pipes to be separately opened or closed.

In some embodiments, the pressure regulating valve is configured to maintain a pressure of the purge gas within the manifold section and the pipe section at a maximum intake pressure. In some embodiments, the pressure regulating valve is located situated between the gas intake and the manifold section or operationally connected to the gas intake and the manifold section. In some embodiments, the pressure regulating valve contains a pressure sensor and the pressure regulating valve is capable of reducing or stopping the flow of gas through the pressure regulating valve in response to pressures higher than the maximum intake pressure. In some embodiments, the initial intake pressure is from about 0.137 MPa to about 4.82 MPa, including from about 0.5 MPa to about 4.0 MPa, including from about 1.0 MPa to about 4.0 MPa. In some embodiments, the maximum intake pressure is from about 0.413 MPa to about 0.517 MPa, including from about 0.40 MPa to about 0.50 MPa, including from about 0.42 MPa to about 0.48 MPa.

In some embodiments, the pressure release valve is mounted on the manifold section at a manifold distal end or located somewhere on the manifold section and operationally connected to the manifold section. In some embodiments, the pressure release valve is configured to limit or maintain a pressure of the purge gas within the manifold section and the pipe section at a maximum safety pressure. In some embodiments, the pressure regulating valve is located or situated on the manifold section and/or one or more of the pipe section or operationally connected thereto. In some embodiments, the pressure release valve contains a pressure sensor, and the pressure release valve is capable of releasing or expelling a gas from the manifold or pipe section into the atmosphere in response to pressures higher than the maximum safety pressure. In some embodiments, the maximum safety pressure is from about 0.689 MPa to about 0.792 MPa, including from about 0.71 MPa to about 0.78 MPa. In some embodiments, the maximum safety pressure is higher than the maximum intake pressure and lower than the initial intake pressure.

In some embodiments, the purge gas includes nitrogen, argon, or mixtures thereof. In some embodiments, the manifold section and the pipe section comprise steel or an allow thereof. In some embodiments, the pipe section includes from 2 to 52 gas pipes, including from 4 to 12 gas pipes, including from 4 to 8 gas pipes. In some embodiments, the threaded joint is a Dixon Ground joint.

In some embodiments, the manifold pipe assembly further includes a pressure sensor disposed on the manifold section between the pressure regulating valve and the pressure release valve. In some embodiments, the pressure sensor is configured to monitor an operating pressure of the manifold section. The “operating pressure” is an actual pressure or measurable or measured pressure inside the manifold section. In some embodiments, the manifold pipe assembly further includes at least one flowmeter mounted on a gas pipe of the pipe section and configured to measure a flow rate of purge gas passing through the gas pipe.

In some embodiments, the intake inlet is configured to connect to a source vessel hose having an internal diameter of about 2.5 cm to about 10.2 cm, including about 3.0 cm to about 9.0 cm. In some embodiments, the pipe distal end is configured to connect to a vessel cargo line having an internal diameter of about 2.5 cm to about 20.4 cm, including about 3.0 cm to about 19.0 cm. In some embodiments, the manifold section has an internal diameter of from about 5.0 cm to about 20.0 cm, including about 6.0 cm to about 19.0 cm.

In some embodiments, the methods disclosed herein include purging vessels by passing an inert gas such as nitrogen, argon, or a mixture thereof, into the destination vessel of the cargo ship. One benefit of nitrogen as a purge gas is that it is much less expensive to purchase. Another benefit of nitrogen as a purge gas can be that it has a lower environmental impact because nitrogen makes up about 78% of the air in the atmosphere.

As described earlier, typical liquid nitrogen pump trucks have a pressure ranging from about 34 MPa to about 103 MPa. In some embodiments, the manifold pipe assembly reduces the pressure to an operating pressure which is less than the maximum intake pressure and the maximum safety pressure before the purge gas, such as nitrogen, is pumped into the hold of a destination vessel. In some embodiments of the manifold pipe assembly, the pressure or operational pressure is safely reduced and maintained under the maximum intake pressure by the pressure regulating valve and the pressure release valve working together. In some embodiments, the method of passing purging gas through manifold pipe assembly initially proceeds at relatively low pressure because there is no back pressure or pressure build up. Instead, the purge gas flows through the initial intake, the manifold section, and pipe section with minimal resistance because the pressure regulating valve is in an open state and the gas flows through unimpeded. However, as the gas fills the vessel and starts pushing the purged and purging gasses out through the exit hose, the pressure throughout the system builds. For example, the pressure can build quickly and suddenly if the crew accidently close a valve, which would lead to over pressuring. Due to the high flow rates of purging gas passing through the manifold pipe assembly, the operational pressure can build suddenly. Once the initial intake pressure measured by the pressure regulating valve passes above the maximum intake pressure, the pressure regulating valve responds by closing or partially closing to keep or maintain the operational pressure below the maximum intake pressure. However, for purging gas tankers, it has been found that even that is not enough because in order to efficiently pump more purge gas through the manifold pipe assembly, back pressures need to be allowed to build up and recede (pressure cycling) to facilitate mixing and a faster purging process. Therefore, in some embodiments, the pressure release valve is designed to allow for pressures higher than the maximum intake pressure to build and be safely released by reducing or limiting or maintaining the operating pressure at or below the maximum safety pressure.

In some embodiments, the reduction or regulation of pressure can be achieved by a pressure manifold pipe assembly by a pressure regulating valve, a pressure sensor, and a pressure release valve. In some embodiments, the pressure regulating valve, the pressure release valve, the flow adjustment valve, and other valves that control the nitrogen flow to the holds maybe manually operated or automatic valves to avoid overpressure and over purging in the disclosed manifold pipe assembly. In some embodiments the flow is counted with an automated flow meter to avoid excess purging. Further, in some embodiments, to enhance safety of the operation, each pipe gas in the disclosed manifold pipe assembly has a separate flowmeter to measure the rate of flow.

In addition, in some embodiments, the manifold pipe assembly implements a threaded joint or Dickson ground joints for connections of the hose from the source vessel (e.g., liquid nitrogen truck) and connections of the gas pipes from the manifold section or splitter portion to the holds of the destination vessel. Dickson ground joints are contemplated in the disclosed manifold pipe assembly because they are pressure approved, safe to use in the context of purging of chemical vessels on cargo ships, and they increase the speed of connecting and disconnecting lines compared to NPT thread (national pipe thread) or flanged connections. In some embodiments, the disclosed embodiments of manifold pipe assembly may implement a thread and wingnut system to attach one joint to another. In some embodiments, manifold pipe assembly implements. In some embodiments, the manifold pipe assembly excludes camlocks because, even though camlocks may be faster for connecting and disconnecting, they are not considered safe for gasses.

In some embodiments, the components of the disclosed embodiments of manifold pipe assembly are made of steel. Further, the disclosed embodiments of the manifold pipe assembly are relatively mobile considering the contemplated size and weight. Due to the dimensions of the disclosed manifold pipe assembly, it can be easily attached to a scaffold on a dock, a boat, or a platform, such as a raft, floating out in the bay or harbor.

Embodiments of a manifold pipe assembly for providing an inert atmosphere in a destination vessel aboard a cargo ship are disclosed. In some embodiments, the manifold pipe assembly includes a manifold section connected to a pipe section. In some embodiments, the manifold section includes an intake inlet at a manifold proximal end configured to receive a purge gas from a source vessel at an initial intake pressure. In some embodiments, the manifold section further includes a pressure regulating valve mounted on the manifold section, proximal to the intake inlet and configured to reduce or limit a pressure of the received purge gas from the initial intake pressure to a maximum intake pressure. In some embodiments, the manifold section further includes a pressure release valve mounted on the manifold section at a manifold distal end. In some embodiments, the manifold section includes a release valve between the intake inlet and the pressure regulation valve.

In some embodiments, the pipe section includes two or more gas pipes connected to the manifold section between the pressure regulating valve and the pressure release valve. In some embodiments, at least one of the two or more gas pipes have a pipe proximal end connected to the manifold section and a pipe distal end that is configured to connect with a vessel cargo line connected to the destination vessel aboard the cargo ship. In some embodiments, the pipe distal end terminates in a threaded joint or flange.

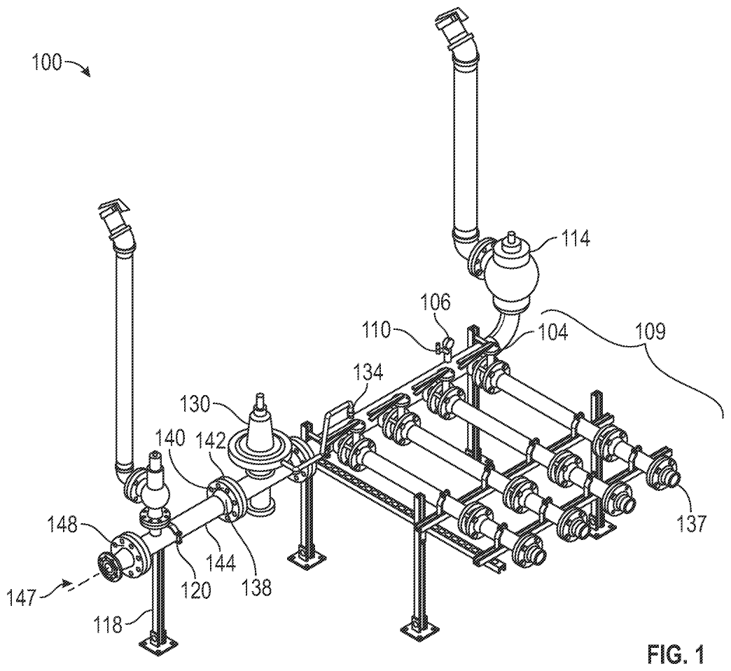

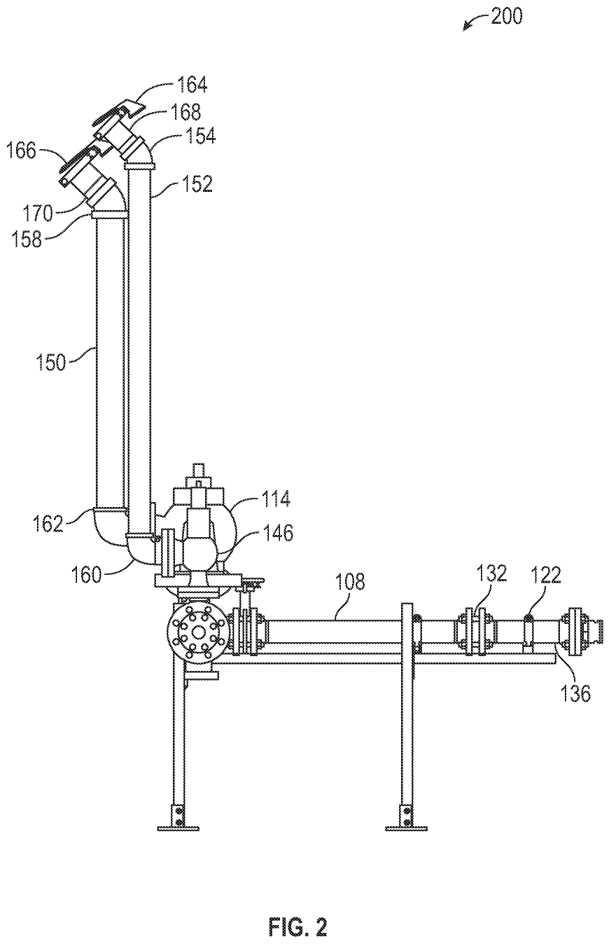

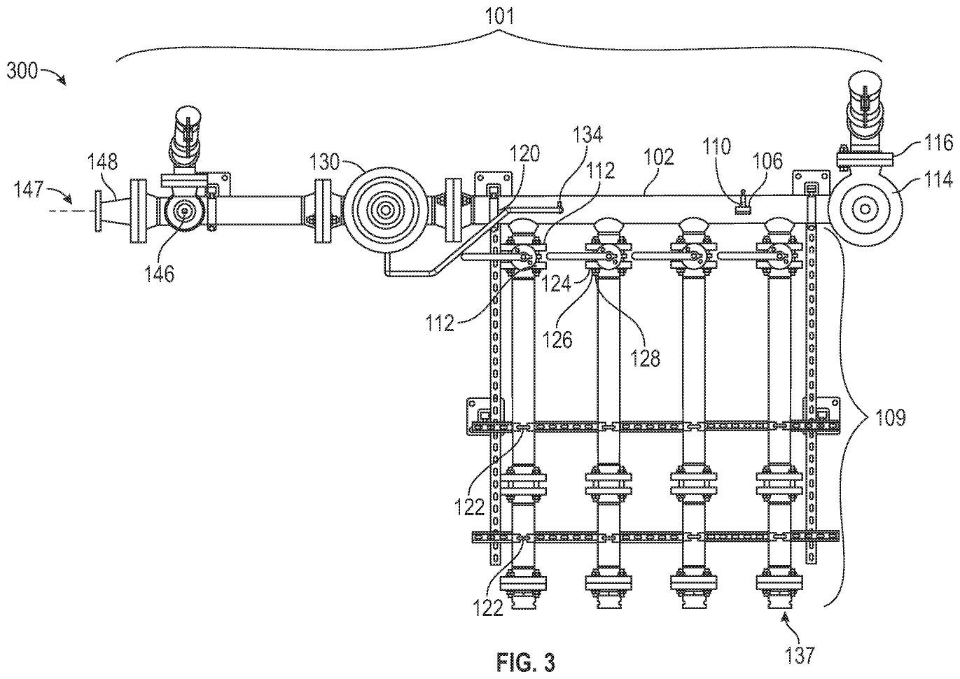

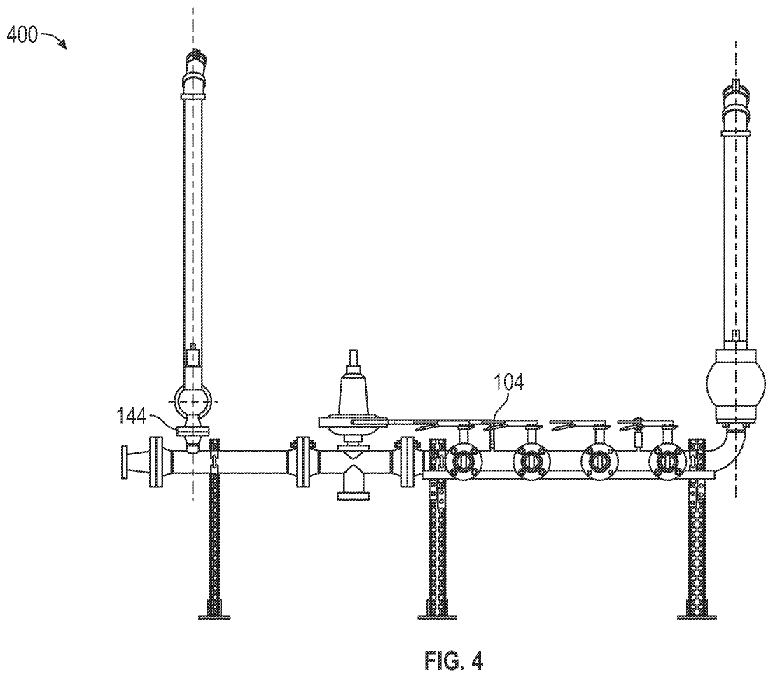

FIG. 1 illustrates a front perspective view 100 of an embodiment of a manifold pipe assembly, in accordance with the present disclosure. FIG. 2 illustrates a left side view 200 of the manifold pipe assembly of FIG. 1, in accordance with an embodiment of the present disclosure. FIG. 3 illustrates a top view 100 of the manifold pipe assembly of FIG. 1, in accordance with an embodiment of the present disclosure. FIG. 4 illustrates a front view 400 of the manifold pipe assembly of FIG. 1, in accordance with an embodiment of the present disclosure. The components or parts of the manifold assembly will be described with reference to FIGS. 1-4. Further, all components or parts have specific dimensions and can be selected based on the design requirements of the manifold pipe assembly disclosed herein. Specific types and dimensions and part numbers of each part or component have not been mentioned for brevity.

In an exemplary embodiment, the manifold pipe assembly includes a manifold section 101 connected to a pipe section 109. The manifold section includes an intake inlet 147 at a manifold proximal end (e.g., left end terminating in a flange fitting or flanged reducer 148 in FIG. 3) configured to receive a purge gas from a source vessel (not shown) at an initial intake pressure. In some embodiments, the intake inlet is configured to connect to a source vessel hose having an internal diameter of about 2.5 cm to about 10.2 cm.

A relief valve 146 is mounted proximal to the flanged reducer 148 along the manifold section to control any pressure fluctuations at the intake inlet. The manifold section further includes a pressure regulating valve 130 mounted on the manifold section, proximal to the intake inlet. The pressure reducing valve 130 is configured to reduce or limit a pressure of the received purge gas from the initial intake pressure to a maximum intake pressure.

The manifold section further includes a pressure release valve 114 mounted on the manifold section at a manifold distal end (e.g., right end of the manifold section as shown in FIG. 1). In some embodiments, an operating pressure is maintained in the manifold section by configuring the pressure regulating valve 130 to a maximum intake pressure and configuring the pressure release valve 114 to release pressures exceeding the maximum safety pressure. In an exemplary embodiment, the maximum safety pressure is from about 0.689 MPa to about 0.792 MPa. In some embodiments, the pressure release valve 114 is configured to release pressure in case of a pressure spike in manifold section due to back pressure (e.g., due to a closed valve aboard the cargo ship or on the manifold pipe assembly).

The manifold section further includes one or more components that enable a mechanically stable connection of one or more gas pipes of the pipe section to the manifold section. For instance, the manifold section includes a manifold weldment 102 that implements a “splitter function” to split the manifold section into multiple openings that enable connection with the one or more gas pipes. The manifold section also includes a plurality of pipe clamps 120 configured to clamp hold the manifold section into a position for connecting to the one or more gas pipes.

The disclosed embodiments envisage various mechanisms for safe and controlled purging operation. Therefore, the manifold section includes one or more components to sense pressure in the manifold section and to regulate it when required. For instance, the manifold weldment 102 has a pressure sensor 106 and a shutoff valve 110 mounted near the manifold distal end. The pressure sensor 106 is disposed on the manifold section between the pressure regulating valve 130 and the pressure release valve 114 and is configured to monitor an operating pressure of the manifold section for safety and regulation purposes. The manifold weldment 102 includes a valve 134 mounted on it near the pressure regulating valve 130. This connection provides the pressure regulating valve feedback on the maximum operating pressure experienced in the manifold.

In more detail, as shown in the FIG. 1, the manifold section further includes a plurality of flange joints or couplings that connect different sub-sections of the manifold section. For example, the relief valve 146 is mounted on a first manifold subsection (e.g., a pipe Tee special 144) that is coupled to a second manifold subsection (on which the pressure regulating valve 130 is mounted) using a flange joint. The flange joint includes a washer 142, a nut 140 and a threaded rod 138. Similarly, the second manifold subsection (on which the pressure regulating valve 130 is mounted) is coupled to the manifold weldment 102 (also referred to as a third manifold subsection) using another flange joint. The first manifold subsection is held in a mechanically stable orientation using another pipe clamp 120 and a Unistrut support 118 that clamps the first manifold subsection securely to a base (e.g., scaffolding base). In some embodiments, the manifold section (e.g., the first manifold subsection, the second manifold subsection, and the third manifold subsection/manifold weldment) has an internal diameter of from about 5.0 cm to about 20.0 cm.

Referring to FIG. 2, the manifold section further includes exhaust mechanisms for releasing a purge gas, such as nitrogen, by operation of the pressure release valve 114 and relief valve 146, respectively. For instance, the relief valve 146 is flange-coupled to a first exhaust mechanism. In some embodiments, the first exhaust mechanism includes a 7.62 cm pipe street elbow 160, a 7.62 cm pipe 152, a 7.62 cm pipe elbow 154, a 7.62 cm pipe nipple 168, and an 8.89 cm exhaust rain cap 164. Similarly, the pressure release valve 114 is flange-coupled to a second exhaust mechanism. In some embodiments, the second exhaust mechanism includes a 10.16 cm pipe street elbow 162, a 10.16 cm pipe 150, a 10.16 cm pipe elbow 158, a 10.16 cm pipe nipple 170 and a 11.43 cm exhaust rain cap 166.

In some embodiments, the pipe section includes four gas pipes (as shown in FIGS. 1 and 3) connected to the manifold section between the pressure regulating valve 130 and the pressure release valve 114. As shown in the figures, the gas pipes can be disposed in parallel to each other. Each of the gas pipes have a pipe proximal end connected to the manifold section (e.g., to the manifold weldment 102) and a pipe distal end 137 that is configured to connect with a vessel cargo line (not shown) connected to the destination vessel aboard the cargo ship. In the example embodiment, although there are four gas pipes shown, it may be understood by those skilled in the art that the number of gas pipes can vary based on the purging requirements of the cargo ship. For instance, if there are eight vessel cargo lines, then the weldment can be made longer, and eight gas pipes can be configured and so on.

The pipe section further includes a flow adjustment valve 104 that is flange-mounted on each of the gas pipes near to the pipe proximal end using a pair of gasket flanges 112 joined by a washer 124, a nut 126, and a threaded rod 128. The flow adjustment valve 104 can be used for independently adjusting the flow of purge gas through individual gas pipes during the purge operation. The pipe section further includes a plurality of pipe clamps 122 and Unistrut supports configured to securely hold the gas pipes in place in a mechanically stable orientation.

In some embodiments, the pipe distal end terminates in a threaded joint or flange. In some embodiments, each of the gas pipes includes a first gas pipe subsection and a second gas pipe subsection. The first gas pipe subsection can be a long spool piece pipe 108 and the second gas pipe subsection can be a short spool piece pipe 136. The pipe section includes a plurality of flange joints or couplings. For instance, the first gas pipe subsection is coupled to the second gas pipe subsection by a flange joint. Similarly, the second gas pipe subsection is flange-coupled to the vessel cargo line at the pipe distal end in an embodiment. In some embodiments, the pipe distal end of each gas pipe is configured to connect to a vessel cargo line (not shown) having an internal diameter of about 2.5 cm to about 20.4 cm.

In some embodiments, the pipe section further includes a flowmeter 132 mounted on or in line with each of the gas pipes and configured to measure a flow rate of purge gas passing through the individual gas pipe.

It may be appreciated by those skilled in the art that one or more customizations may be made to one or more components or parts of the disclosed embodiments of the manifold pipe assembly without departing from the scope of the ongoing description. Such customizations can be made based on flow rates, pressure ranges and other such variables corresponding to the specifications of hoses connecting the source vessel to the manifold pipe assembly and hoses connecting the destination vessel to the manifold pipe assembly.

Other factors that can be considered for customizations include ship piping sizes, distances between the destination vessel and the manifold pipe assembly and working or operating pressures throughout the purging operation, and volume of purge gas passing through the hoses at the operating pressures. For example, a larger (e.g., 7.62 cm) hose would reduce some issues while moving a higher volume of purge gas.

Embodiments of a system for providing inert atmosphere in a destination vessel aboard a cargo ship are disclosed herein. In some embodiments, the system includes a source vessel, such as a liquid nitrogen truck, connected to a manifold pipe assembly, wherein the manifold pipe assembly is connected to the destination vessel aboard the cargo ship. In some embodiments, the manifold pipe assembly includes a manifold section connected to a pipe section. In some embodiments, the manifold section includes an intake inlet at a manifold proximal end configured to receive a purge gas from the source vessel at an initial intake pressure. In some embodiments, the manifold section further includes a pressure regulating valve (e.g., 130) mounted on the manifold section proximal to the intake inlet and configured to limit or reduce a pressure of the received purge gas from the intake value to a maximum intake pressure. In some embodiments, the manifold section further includes a pressure release valve (e.g., 114) mounted on the manifold section at a manifold distal end.

In some embodiments, the pipe section includes two or more gas pipes connected to the manifold section between the pressure regulating valve (e.g., 130) and the pressure release valve (e.g., 114). In some embodiments, at least one of the two or more gas pipes have a pipe proximal end connected to the manifold section and a pipe distal end that is configured to connect with a vessel cargo line connected to the destination vessel aboard the cargo ship. In some embodiments, the pipe distal end terminates in a threaded joint or flange.

Embodiments of a method for providing an inert atmosphere in a destination vessel aboard a cargo ship are disclosed. In some embodiments, there may be a plurality of destination vessels aboard the cargo ship. In some embodiments, the method includes providing a manifold pipe assembly. In some embodiments, the providing includes providing the manifold pipe assembly attached to a scaffold on a dock, a boat, or a platform, such as a raft, floating out in the bay or harbor.

In some embodiments of the method, the manifold pipe assembly includes a manifold section connected to a pipe section. In some embodiments, the manifold section includes an intake inlet at a manifold proximal end, a pressure regulating valve (130) mounted on the manifold section proximal to the intake inlet, and a pressure release valve (114) mounted on the manifold section at a manifold distal end. Further, in some embodiments, the pipe section includes two or more gas pipes connected to the manifold section between the pressure regulating valve and the pressure release valve. In some embodiments, at least one of the two or more gas pipes have a pipe proximal end connected to the manifold section and a pipe distal end that terminates in a threaded joint (or a flange).

In some embodiments, the method further includes connecting the intake inlet to a source vessel, such as a liquid nitrogen truck, containing a purge gas, such as nitrogen, in a gas or liquid form and connecting the threaded joint of the pipe distal end to a vessel cargo line. In some embodiments, the vessel cargo line is connected to the destination vessel aboard the cargo ship. A benefit of the threaded joints or flange joints disclosed herein can be to provide for efficient connection and disconnection of the source vessel to the intake inlet.

In some embodiments, the method further includes passing purge gas from the source vessel into the intake inlet and reducing the initial intake pressure to a maximum intake pressure by passing the purge gas through the pressure regulating valve (130). In some embodiments of the method, the initial intake pressure is from about 1.37 MPa to about 4.82 MPa. In some embodiments of the method, the maximum intake pressure is from about 0.413 MPa to about 0.517 MPa.

In some embodiments, the method further includes flowing the purge gas through the pipe section and the vessel cargo line to the destination vessel and reducing an oxygen content of an atmosphere in the destination vessel to from about 10 ppm to about 70,000 ppm volume (concentration) of oxygen, including about 50 ppm to about 60,000 ppm, including from about 100 ppm to about 50,000, based on a total volume of the destination vessel. In some embodiments, the destination vessel has a capacity of from about 367,000 liters to about 3,000,000 liters. In some embodiments, the source vessel is a vehicle containing liquid nitrogen, a truck containing liquid nitrogen, a boat containing liquid nitrogen, or a raft or dock containing liquid nitrogen. In some embodiments, the source vessel is a vehicle containing nitrogen gas in a pressurized tank, a truck containing nitrogen gas in nitrogen gas in a pressurized tank, a boat containing nitrogen gas in a pressurized tank, or a raft or dock containing nitrogen gas in a pressurized tank. In some embodiments, the gas is supplied via a pipeline directly from a producer of nitrogen

In some embodiments, the method further includes, before passing purge gas from the source vessel, connecting a source vessel hose to the source vessel (at one end) and to the intake inlet (at the other end). In some embodiments, the source hose has an internal diameter of from about 3.8 cm to about 9.0 cm. In some embodiments, the method further includes, before flowing the purge gas through the pipe section, connecting a vessel cargo line to the pipe distal end. In some embodiments, the vessel cargo line has an internal diameter of from about 5.0 cm to about 11.0 cm. In some embodiments, the method further includes, before flowing the purge gas through the pipe section, connecting a gas exit hose to the destination vessel to an exit port of the destination vessel. In some embodiments, the gas exit hose has an exit end that extends from about 3.0 meters to about 20.0 meters away from the destination vessel.

In some embodiments, the method further includes, maintaining a pressure in the manifold section of an operating pressure by configuring the pressure regulating valve (130) to a maximum intake pressure and configuring the pressure release valve (114) to release pressures exceeding the maximum safety pressure. In some embodiments, the maximum safety pressure is from about 0.689 MPa to about 0.792 MPa. In some embodiments, the method further includes, monitoring an operating pressure of the manifold pipe assembly by a pressure sensor (106) disposed on the manifold section between the pressure regulating valve (130) and the pressure release valve (114). The method further includes, regulating a pressure of purge gas, in each of two or more gas pipes by a flowmeter (132) mounted on the two or more gas pipes.

The disclosure may be embodied in other specific forms without departing from the spirit or essential characteristics thereof. The present embodiments are therefore to be considered in all respects as illustrative and not restrictive, the scope of the disclosure being indicated by the claims of the application rather than by the foregoing description, and all changes which come within the meaning and range of equivalency of the claims are therefore intended to be embraced therein.

### EXAMPLES

Piping supplies were purchased from Grainger (Lake Forest, IL), McMaster Carr (Houston, TX), Ferguson (Houston, TX) or custom machined to specification. The pressure regulating valves and pressure release valves were purchased from Beaumont Manufacturing (Beaumont, TX) or Cashco (Ellsworth, KS) or Fisher Control Valve (Houston, TX) or Flomatic Valves (Glens Falls, NY). The pieces were assembled as illustrated in FIGS. 1-4.

What is claimed is:

1. A manifold pipe assembly for providing an inert atmosphere in a destination vessel aboard a cargo ship, the manifold pipe assembly comprising:
a manifold section connected to a pipe section, wherein the manifold section comprises:
an intake inlet at a manifold proximal end configured to receive a purge gas from a source vessel at an initial intake pressure;
a pressure regulating valve mounted on the manifold section, proximal to the intake inlet and configured to reduce or limit a pressure of the received purge gas from the initial intake pressure to a maximum intake pressure; and
a pressure release valve mounted on the manifold section at a manifold distal end,
wherein the pipe section includes two or more gas pipes connected to the manifold section between the pressure regulating valve and the pressure release valve, wherein at least one of the two or more gas pipes have a pipe proximal end connected to the manifold section and a pipe distal end that is configured to connect with a vessel cargo line connected to the destination vessel aboard the cargo ship, and wherein the pipe distal end terminates in a threaded joint or flange.

2. The manifold pipe assembly of claim 1, wherein the pressure regulating valve is configured to maintain a pressure of the purge gas within the manifold section and the pipe section at a maximum safety pressure, wherein the maximum safety pressure is higher than the maximum intake pressure and lower than the initial intake pressure.

3. The manifold pipe assembly of claim 1, wherein the pipe section comprises from 2 to 52 gas pipes.

4. The manifold pipe assembly of claim 1, wherein the threaded joint is a Dixon Ground joint.

5. The manifold pipe assembly of claim 1, wherein the initial intake pressure is from about 1.37 MPa to about 4.82 MPa.

6. The manifold pipe assembly of claim 1, wherein the maximum intake pressure is from about 0.413 MPa to about 0.517 MPa.

7. The manifold pipe assembly of claim 1, wherein the maximum safety pressure is from about 0.689 MPa to about 0.792 MPa.

8. The manifold pipe assembly of claim 1, wherein the purge gas comprises nitrogen, argon, or mixtures thereof.

9. The manifold pipe assembly of claim 1, wherein the manifold section and the pipe section comprise steel.

10. The manifold pipe assembly of claim 1, further comprising a pressure sensor disposed on the manifold section between the pressure regulating valve and the pressure release valve, wherein the pressure sensor is configured to monitor an operating pressure of the manifold section.

11. The manifold pipe assembly of claim 1, further comprising at least one flowmeter mounted on a gas pipe of the pipe section and configured to measure a flow rate of purge gas passing through the gas pipe.

12. The manifold pipe assembly of claim 1, wherein the intake inlet is configured to connect to a source vessel hose having an internal diameter of about 2.5 cm to about 10.2 cm.

13. The manifold pipe assembly of claim 1, wherein pipe distal end is configured to connect to a vessel cargo line having an internal diameter of about 2.5 cm to about 20.4 cm.

14. The manifold pipe assembly of claim 1, wherein the manifold section has an internal diameter of from about 5.0 cm to about 20.0 cm.

15. A method for providing an inert atmosphere in a destination vessel aboard a cargo ship, the method comprising:
providing a manifold pipe assembly, the manifold pipe assembly comprising:
a manifold section connected to a pipe section, wherein the manifold section comprises:
an intake inlet at a manifold proximal end;
a pressure regulating valve mounted on the manifold section proximal to the intake inlet; and
a pressure release valve mounted on the manifold section at a manifold distal end;
wherein the pipe section includes two or more gas pipes connected to the manifold section between the pressure regulating valve and the pressure release valve,
wherein at least one of the two or more gas pipes have a pipe proximal end connected to the manifold section and a pipe distal end that terminates in a threaded joint;
connecting the intake inlet to a source vessel containing a purge gas in a gas or liquid form; and
connecting the threaded joint of the pipe distal end to a vessel cargo line, wherein the vessel cargo line is connected to the destination vessel aboard the cargo ship.

16. The method of claim 15, further comprising:
passing purge gas from the source vessel into the intake inlet; and
reducing the initial intake pressure to a maximum intake pressure by passing the purge gas through the pressure regulating valve,
wherein the initial intake pressure is from about 1.37 MPa to about 4.82 MPa; or
wherein the maximum intake pressure is from about 0.413 MPa to about 0.517 MPa.

17. The method of claim 16, further comprising:
flowing the purge gas through the pipe section and the vessel cargo line to the destination vessel; and
reducing an oxygen content of an atmosphere in the destination vessel to from about 10 ppm to about 70,000 ppm volume of oxygen, based on a total volume of the destination vessel.

18. The method of claim 17, wherein the destination vessel has a capacity of from about 367,000 liters to about 3,000,000 liters.

19. The method of claim 16, further comprising, before passing purge gas from the source vessel,
connecting a source vessel hose to the source vessel and to the intake inlet, wherein the source hose has an internal diameter of from about 3.8 cm to about 9.0 cm.

20. The method of claim 17, further comprising, before flowing the purge gas through the pipe section,
connecting a vessel cargo line to the pipe distal end, wherein the vessel cargo line has an internal diameter of from about 5.0 cm to about 11.0 cm.

21. The method of claim 17, further comprising, before flowing the purge gas through the pipe section,
connecting a gas exit hose to the destination vessel to an exit port of the destination vessel, wherein the gas exit hose has an exit end that extends from about 3.0 meters to about 20 meters away from the destination vessel.

22. The method of claim 17, further comprising, maintaining a pressure in the manifold section of an operating pressure by configuring the pressure regulating valve to a maximum intake pressure and configuring the pressure release valve to release pressures exceeding the operating pressure, wherein the operating pressure is from about 0.689 MPa to about 0.792 MPa.

23. The method of claim 17, further comprising, monitoring an operating pressure of the manifold pipe assembly by a pressure sensor disposed on the manifold section between the pressure regulating valve and the pressure release valve.

24. The method of claim 17, further comprising, regulating a pressure of purge gas, in each of two or more gas pipes by a flowmeter mounted on the two or more gas pipes.

25. A system for providing inert atmosphere in a destination vessel aboard a cargo ship, the system comprising:
a source vessel connected to a manifold pipe assembly, wherein the manifold pipe assembly is connected to the destination vessel aboard the cargo ship, wherein the manifold pipe assembly comprises:
a manifold section connected to a pipe section, wherein the manifold section comprises:
an intake inlet at a manifold proximal end configured to receive a purge gas from the source vessel at an initial intake pressure;
a pressure regulating valve mounted on the manifold section proximal to the intake inlet and configured to limit or reduce a pressure of the received purge gas from the intake value to a maximum intake pressure; and
a pressure release valve mounted on the manifold section at a manifold distal end;
wherein the pipe section includes two or more gas pipes connected to the manifold section between the pressure regulating valve and the pressure release valve, wherein at least one of the two or more gas pipes have a pipe proximal end connected to the manifold section and a pipe distal end that is configured to connect with a vessel cargo line connected to the destination vessel aboard the cargo ship, and wherein the pipe distal end terminates in a threaded joint or flange.
